(19) United States
(12) Patent Application Publication
(10) Pub. No.: US 2017/0013982 A1
(43) Pub. Date: Jan. 19, 2017

(54) ILLUMINATING DRINKING CUP WITH AUDIO PLAYBACK

(71) Applicant: Steven Amaru, Atkinson, NH (US)

(72) Inventor: Steven Amaru, Atkinson, NH (US)

(21) Appl. No.: 14/803,084

(22) Filed: Jul. 19, 2015

(51) Int. Cl. A47G 19/22; G08B 21/24; F21V 23/04; F21L 4/00; F21V 33/00; F21V 23/00

(52) U.S. Cl. CPC A47G 19/2227; A47G 19/2272; F21V 33/0036; F21V 33/0056; F21V 23/003; F21V 23/0435; F21L 4/00; G08B 21/24; A47G 2019/2238; A47G 2019/2244; F21W 2121/00

(57) ABSTRACT

An illuminating sippy cup with audio playback for providing entertainment for a child and for improving the ability to locate it once misplaced. The illuminating sippy cup with audio playback is embodied as either a conventionally styled sippy cup with an electronics housing built in or as a conventional sippy cup with a discrete electronics housing attached to it. In either embodiment, the illuminating sippy cup with audio playback additionally includes a plurality of external lighting elements operatively connected to the electronics housing, in which the primary of the operative components of the illuminating sippy cup with audio playback are included. A wireless remote control is provided to enable a user to transmit wireless command signals to the illuminating sippy cup with audio playback, thereby causing it to selectively activate the lighting elements and/or play sound over the speakers.

### BACKGROUND OF THE INVENTION

Field of the Invention

This invention relates generally to drinking receptacles and, more particularly, to a child drinking cup having remote actuated audible and illuminating components.

Description of the Prior Art

The use of sippy cups or other spill proof drinking cups for babies and toddlers is well established. It is generally observed that children enjoy drinking from such sippy cups as they transition away from being fed with bottles held by a caregiver as sippy cups offer a level of independence to the child to hold their own drinking receptacle. A problem which still exists, however, is that with this new independence to hold and carry around they own cup, children often times leave their sippy cup wherever they lose interest in holding it, making it difficult for the child or the caregiver to subsequently find. This same issue arises in the event that the child hides their sippy cup and subsequently forgets the location in which it is hidden. Thus, there remains a need for an illuminating sippy cup with audio playback which would allow a caregiver to activate integral lighting and audio elements on a sippy cup so as to allow it to be located. It would be helpful if such an illuminating sippy cup with audio playback included a wireless remote control which allowed for the lighting and audio elements to be activated remotely. It would be additionally desirable for the functionality of such an illuminating sippy cup with audio playback to be provided through either a built in electronics housing in a cup or a component housing attachment for existing cups.

The Applicant's invention described herein provides for an illuminating sippy cup with audio playback adapted to allow a user to generate remotely activate lighting and audio elements integrated on a sippy cup. The primary components in Applicant's illuminating sippy cup with audio playback are an electronics housing with controller, a lighting system and audio system, as well as a remote control. When in operation, the illuminating sippy cup with audio playback enables a caregiver to locate a misplaced sippy cup through the generation of sensory stimuli which reveal its location. As a result, many of the limitations imposed by prior art structures are removed.

### SUMMARY OF THE INVENTION

An illuminating sippy cup with audio playback for providing entertainment for a child and for improving the ability to locate it once misplaced. The illuminating sippy cup with audio playback is embodied as either a conventionally styled sippy cup with an electronics housing built in or as a conventional sippy cup with a discrete electronics housing attached to it. In either embodiment, the illuminating sippy cup with audio playback additionally includes a plurality of external lighting elements operatively connected to the electronics housing, in which the primary of the operative components of the illuminating sippy cup with audio playback are included. A wireless remote control is provided to enable a user to transmit wireless command signals to the illuminating sippy cup with audio playback, thereby causing it to selectively activate the lighting elements and/or play sound over the speakers.

It is an object of this invention to provide an illuminating sippy cup with audio playback which would allow a caregiver to activate integral lighting and audio elements on a sippy cup so as to allow it to be located.

It is another object of this invention to provide an illuminating sippy cup with audio playback that includes a wireless remote control which allowed for the lighting and audio elements to be activated remotely.

It is yet another object of this invention to provide an illuminating sippy cup with audio playback with its functionality implemented through either a built in electronics housing in a cup or a component housing attachment for existing cups.

These and other objects will be apparent to one of skill in the art.

### BRIEF DESCRIPTION OF THE DRAWINGS

FIG. 1 is a side perspective view of an illuminating sippy cup with audio playback built in accordance with the integrated embodiment of the present invention.

FIG. 2 is an elevational view of a cross section of an illuminating sippy cup with audio playback built in accordance with the integrated embodiment of the present invention.

FIG. 3 is a side perspective view of an illuminating sippy cup with audio playback built in accordance with the attachment embodiment of the present invention.

FIG. 4 is a side perspective view of a remote control of an illuminating sippy cup with audio playback built in accordance with the present invention.

### DETAILED DESCRIPTION OF THE INVENTION

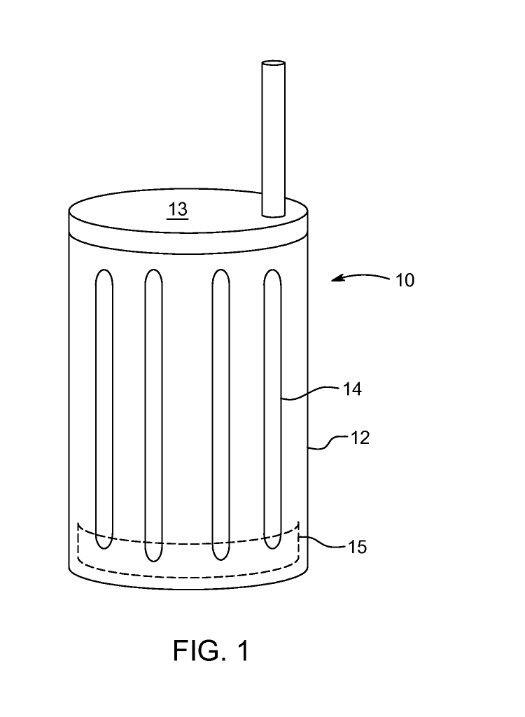

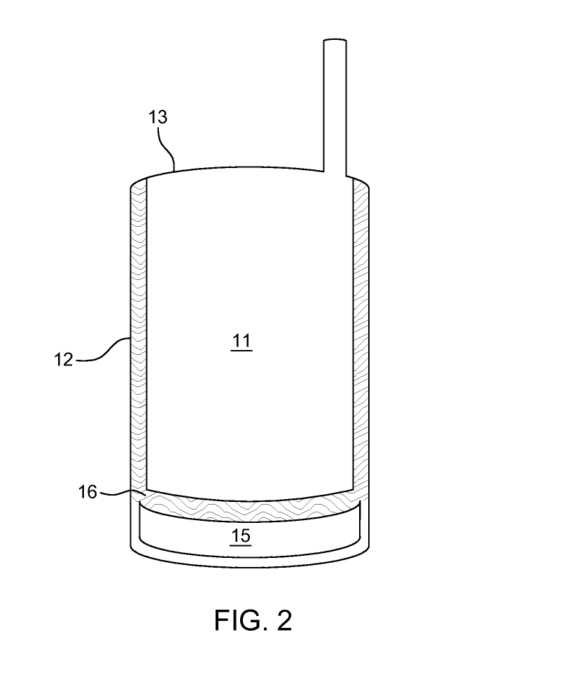

Referring now to the drawings and in particular FIGS. 1 and 2, an illuminating sippy cup with audio playback 10 (or “sensory sippy cup”) is shown as a conventionally styled sippy cup body having a receptacle area 11 for holding a liquid, an exterior surface 12, and a top 13. The sensory sippy cup additionally includes 10 a plurality of lighting elements 14 are disposed along its exterior surface 12 and an internal electronics housing 15 disposed beneath the receptacle area 11, with the electronics housing 15 in operatively connected with the lighting elements 14 through electrical wiring.

It is appreciated that between the receptacle area 11 and the electronics housing 15 an insulation layer 16 may be included to keep the electronics housing 15 isolated from moisture or extreme temperatures in the receptacle area 11.

The electronics housing 15 includes a microcontroller, a memory element, a sound card, an antenna, a speaker, and an onboard power source, all interconnected to one another. In one embodiment, the power source is defined as a battery. Accordingly, the microcontroller is operative to receive command signals from the antenna and, in response to such command signals, cause the lighting elements 14 to selectively illuminate and/or cause a data file stored on the memory element to be processed by the sound card into an audio signal and then played over the speaker. In the preferred embodiment, the microcontroller is programmed to receive an illuminating command signal which causes it to activate the lighting elements 14 and a audio command signal which causes it to play sound over the speakers.

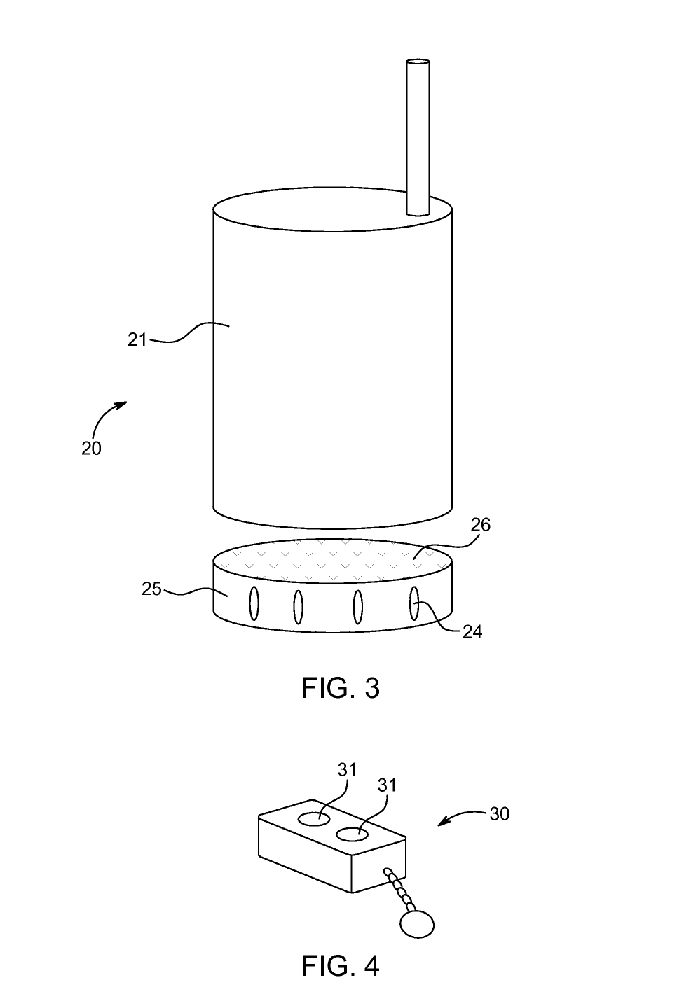

Referring now to FIG. 3, in an alternate embodiment, the illuminating sippy cup with audio playback 20 (or “sensory sippy cup”) defines a conventional sippy cup 21 with which an electronics housing attachment 25 has been removably coupled. In this embodiment, other than the lighting elements 24 being disposed on the electronics housing attachment 25 as opposed to the sippy cup 21, the electronics housing attachment 25 operates in the same manner in the embodiment described in FIGS. 1 and 2. It is contemplated that the electronics housing attachment 25 is removably attachable to the bottom of the sippy cup 21 through the use of a hook and loop fastener, with the hook surface 26 on the electronics housing attachment 25 and the loop surface on the bottom of the sippy cup 21. In other embodiments, however, the electronics housing attachment 25 may be coupled with the sippy cup 21 through an adhesive.

Referring now to FIG. 4, a wireless remote control 30 is provided to enable a user to transmit wireless command signals to either embodiment of the sensory sippy cup 10, 20. The wireless remote control 30 includes two manual actuator buttons 31, each coupled with a separate internal electric switch, which corresponds to a discrete command signal. As such, one of the actuator buttons 31 is configured to correspond to the illuminating command signal and the to the audio command signal.

The electric switches are operatively connected with an internal controller, remote antenna, and power source through electrical wires inside the remote control 30. Accordingly, by manually actuating one of the actuator buttons 31, the switch signals the internal controller to transmit the corresponding command signal over the remote antenna.

In the preferred embodiment, the antenna and remote antenna define conventional RF antennae. In other embodiments, the antenna and remote antenna define wireless networking interfaces, such as WLAN or PAN antennae.

In operation, it is contemplated that the activation of the lighting elements will cause the lighting elements to flash thereby making the sensory sippy cup easier to locate or entertaining a child. Similarly, it is contemplated that the speakers may be operative to play a song or animal sounds over the speakers to entertain a child or play an alert sound (such as a buzzer) to make the sensory sippy cup easier to locate. In one embodiment, a short press of the audio command actuator button causes entertaining audio to play and a long press causes an alert sound to play.

In various embodiments, the audio played by the speakers includes educational content that is entertaining.

In one embodiment, the electronics housing additionally includes a scale operative to determine the level of fluid in the sensory sippy cup at a given moment. In such an embodiment, the scale monitors the net weight of the fluid by setting a tare weight when initially activated.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A sensory sippy cup, comprising:
an electronics housing integral with a drinking receptacle, wherein said electronics housing includes an electrically interconnected microcontroller, memory element, sound card, speaker, and onboard power source;
at least one lighting element operatively connected with said power source;
said microcontroller configured to receive at least a first discrete and second discrete command signal and, in response to receiving the first command signal, selectively cause electricity from the power source to be supplied to the at least one lighting element, thereby causing it to illuminate; and
said microcontroller configured to, in response to receiving the second command signal, selectively cause a data file stored on the memory element to be processed by the sound card into an audio signal and then played over the speaker.

2. The sensory sippy cup of claim 1, wherein said electronics housing additionally includes an antenna that is electrically connected to said microcontroller and said microcontroller is configured to receive through the antenna the first discrete command signal and second discrete command signal.

3. The sensory sippy cup of claim 2, additionally comprising a remote control having at least one manual actuator and configured to wirelessly transmit the first discrete command signal and second discrete command signal in response to manual actuation of the at least one manual actuator.

4. The sensory sippy cup of claim 3, wherein said at least one manual actuator defines a first manual actuator which corresponds solely to the first discrete command signal and a second manual actuator which corresponds solely to the second discrete command signal.

5. The sensory sippy cup of claim 1, wherein said electronics housing is removably coupled with said drinking receptacle.

6. A sensory sippy cup, comprising:
an electronics housing integral with a drinking receptacle, wherein said electronics housing includes an electrically interconnected microcontroller, memory element, sound card, antenna, speaker, and onboard power source;
at least one lighting element operatively connected with said power source;
said microcontroller configured to receive at least a first discrete and second discrete command signal through the antenna and, in response to receiving the first command signal, selectively cause electricity from the power source to be supplied to the at least one lighting element, thereby causing it to illuminate; and
said microcontroller configured to, in response to receiving the second command signal, selectively cause a data file stored on the memory element to be processed by the sound card into an audio signal and then played over the speaker.

7. The sensory sippy cup of claim 6, additionally comprising a remote control having at least one manual actuator and configured to wirelessly transmit the first discrete command signal and second discrete command signal in response to manual actuation of the at least one manual actuator.

8. The sensory sippy cup of claim 7, wherein said at least one manual actuator defines a first manual actuator which corresponds solely to the first discrete command signal and a second manual actuator which corresponds solely to the second discrete command signal.

9. The sensory sippy cup of claim 7, wherein said electronics housing is removably coupled with said drinking receptacle.

10. The sensory sippy cup of claim 6, wherein said electronics housing is removably coupled with said drinking receptacle.
